(19) United States
(12) Patent Application Publication
(10) Pub. No.: US 2026/0051531 A1
(43) Pub. Date: Feb. 19, 2026

(54) COMPOUND, ELECTROLYTE FOR RECHARGEABLE LITHIUM BATTERY INCLUDING THE SAME, AND RECHARGEABLE LITHIUM BATTERY INCLUDING THE SAME

(71) Applicant: SAMSUNG SDI CO., LTD., Yongin-si (KR)

(72) Inventors: Erang CHO, Yongin-si (KR); Sujeong KOH, Yongin-si (KR); JIN-HYEOK LIM, Yongin-si (KR); JINAH SEO, Yongin-si (KR); Bomee KWON, Yongin-si (KR); SUNDAE KIM, Yongin-si (KR); Euisoo JEONG, Yongin-si (KR); SANGHOON KIM, Yongin-si (KR)

(21) Appl. No.: 19/227,328

(22) Filed: Jun. 3, 2025

(30) Foreign Application Priority Data
Aug. 13, 2024 (KR) 10-2024-0108003

(51) Int. Cl. H01M 10/0525; H01M 4/02; H01M 4/36; H01M 4/38; H01M 4/525; H01M 4/583; H01M 10/0567; H01M 10/0568; H01M 10/0569

(52) U.S. Cl. CPC H01M 10/0525; H01M 4/364; H01M 4/386; H01M 4/387; H01M 4/525; H01M 4/583; H01M 10/0567; H01M 10/0568; H01M 10/0569; H01M 2004/027; H01M 2004/028; H01M 2300/0037; H01M 2300/0051

(57) ABSTRACT

A rechargeable lithium battery includes: a positive electrode including a positive electrode active material; a negative electrode including a negative electrode active material; and an electrolyte for the rechargeable lithium battery. The electrolyte includes a non-aqueous organic solvent, a lithium salt, and an additive. The additive includes a cyclic carbonate-based compound comprising an azide-containing group.

### CROSS-REFERENCE TO RELATED APPLICATION

The present application claims priority to and the benefit of Korean Patent Application No. 10-2024-0108003, filed on Aug. 13, 2024, in the Korean Intellectual Property Office, the entire disclosure of which is incorporated herein by reference.

### BACKGROUND

One or more aspects of embodiments of the present disclosure are directed toward a compound, an electrolyte for a rechargeable lithium battery including the compound, and a rechargeable lithium battery including the electrolyte.

With the recent increase in the use of battery-powered electronic devices (such as mobile phones and/or laptop computers), and/or electric vehicles, the demand for rechargeable batteries with high energy density and high capacity has also increased. To account for this increase in demand, research to improve performance of rechargeable lithium batteries has been ongoing.

A rechargeable lithium battery includes a positive electrode, a negative electrode, and an electrolyte, where the positive and negative electrodes include an active material in which intercalation and deintercalation (of lithium ions) are possible. The rechargeable lithium battery generates electrical energy caused by oxidation and reduction reactions if (e.g., when) lithium ions are intercalated and deintercalated.

A lithium salt dissolved in a non-aqueous organic solvent may be used as the electrolyte of the rechargeable lithium battery. The characteristics of the rechargeable lithium battery are exhibited (e.g., are influenced) by complex reactions between the positive electrode and the electrolyte and between the negative electrode and the electrolyte. Accordingly, the use of an appropriate or suitable electrolyte is an important variable for improvement of the rechargeable lithium battery.

### SUMMARY

One or more aspects of embodiments of the present disclosure are directed toward an additive with (having) an enhanced (e.g., excellent or suitable) effect of improving battery performance at (relatively) high voltages and (relatively) high temperatures.

One or more aspects of embodiments of the present disclosure are directed toward a rechargeable lithium battery with (having) enhanced (e.g., excellent or suitable performance) at (relatively) high voltages and (relatively) high temperatures. Additional aspects will be set forth in part in the description which follows and, in part, will be apparent from the description, or may be learned by practice of the presented embodiments of the disclosure.

According to one or more embodiments of the present disclosure, an electrolyte for a rechargeable lithium battery may include: a non-aqueous organic solvent; a lithium salt; and an additive. The additive may include a cyclic carbonate-based compound including an azide-containing group.

According to one or more embodiments of the present disclosure, a cyclic carbonate-based compound may be represented by Chemical Formula 1 or Chemical Formula 2.

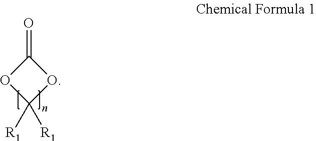

In Chemical Formula 1,

The subscript n may be an integer of 2 to 5,
R₁(s) may each independently be hydrogen, a substituted or unsubstituted C1 to C10 alkyl group, a substituted or unsubstituted C2 to C10 alkenyl group, a substituted or unsubstituted C2 to C10 alkynyl group, or an azide-containing group,
R₁(s) may be substantially identical to or different from each other, and
at least one of R₁(s) may be the azide-containing group.

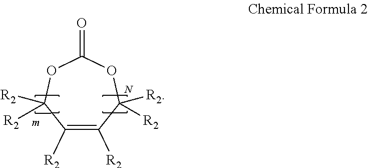

In Chemical Formula 2,

The subscript m may be an integer of 0 to 3,

The subscript z may be an integer of 0 to 3,

A sum of m and z may be an integer of equal to or less than 3,
R₂(s) may each independently be hydrogen, a substituted or unsubstituted C1 to C10 alkyl group, a substituted or unsubstituted C2 to C10 alkenyl group, a substituted or unsubstituted C2 to C10 alkynyl group, or the azide-containing group,
R₂(s) may be substantially identical to or different from each other, and
at least one of R₂(s) may be the azide-containing group.

According to one or more embodiments of the present disclosure, a rechargeable lithium battery may include: a positive electrode that includes a positive electrode active material; a negative electrode that includes a negative electrode active material; and the electrolyte for the rechargeable lithium battery.

### BRIEF DESCRIPTION OF DRAWINGS

These and/or other aspects will become apparent and more readily appreciated from the following description of the embodiments, taken in conjunction with the accompanying drawings in which:

FIG. 1 illustrates a simplified conceptual diagram showing a rechargeable lithium battery according to one or more embodiments of the present disclosure.

FIGS. 2-5 illustrate simplified diagrams each showing a rechargeable lithium battery according to one or more embodiments of the present disclosure, with FIG. 2 showing a cylindrical battery, FIG. 3 showing a prismatic battery, and FIGS. 4 and 5 showing pouch-type (kind) batteries.

FIG. 6 illustrates a graph showing 1H-NMR spectrum results of a compound according to Synthesis Example 1.

### DETAILED DESCRIPTION

The present disclosure will now be described in more detail with reference to the accompanying drawings. It should be noted, however, that the present disclosure is not limited to the following example embodiments, and may be implemented in one or more suitable forms. Rather, the example embodiments are provided only to describe the present disclosure and let those skilled in the art to fully understand the scope of the present disclosure.

In this description, it will be understood that, if (e.g., when) an element is referred to as being on another element, the element can be directly on the other element or intervening elements may be present between therebetween. By way of contrast, if an element is referred to as being directly on another element, no intervening elements may be present therebetween. In the drawings, sizes and/or thicknesses of some components are exaggerated for purposes of explaining the technical contents. Like reference numerals refer to like elements throughout the specification, and duplicative descriptions thereof may not be provided.

Unless otherwise specially noted in this description, the expression of singular form may include the expression of plural form. In addition, unless otherwise specially noted, the phrase “A or B” may indicate “A but not B”, “B but not A”, and “A and B”. The terms “comprises/includes” and/or “comprising/including” used in this description do not exclude the presence or addition of one or more other components. Additionally, the terms “comprise(s)/comprising,” “include(s)/including,” “have/has/having” or similar terms include or support the terms “consisting of” and “consisting essentially of,” indicating the presence of stated features, integers, steps, operations, elements, and/or components, without or essentially without the presence of other features, integers, steps, operations, elements, components, and/or groups thereof.

In this description, the term “combination thereof” may refer to a mixture, a stack, a composite, a copolymer, an alloy, a blend, or a reaction product.

It will be understood that, although the terms first, second, etc. may be used herein to describe various elements, these elements should not be limited by these terms. These terms are only used to distinguish one element from another element. Thus, a first element could be termed a second element without departing from the teachings of the present invention. Similarly, a second element could be termed a first element.

As used herein, the terms “use,” “using,” and “used” may be considered synonymous with the terms “utilize,” “utilizing,” and “utilized,” respectively.

As used herein, expressions such as “at least one of”, “one of”, and “selected from”, when preceding a list of elements, modify the entire list of elements and do not modify the individual elements of the list. For example, “at least one selected from among a, b and c”, “at least one of a, b or c”, and “at least one of a, b and/or c” may indicate only a, only b, only c, both (e.g., simultaneously) a and b, both (e.g., simultaneously) a and c, both (e.g., simultaneously) b and c, all of a, b, and c, or variations thereof.

As used herein, the term “and/or” includes any and all combinations of one or more of the associated listed items.

Further, the use of “may” when describing embodiments of the present disclosure refers to “one or more embodiments of the present disclosure”.

Unless otherwise especially defined in this description, a particle diameter may be an average particle diameter. In addition, a particle diameter indicates an average particle diameter (D₅₀) where a cumulative volume is about 50 volume % in a particle size distribution. The average particle diameter (D₅₀) may be measured by any suitable method in the art, for example, by a particle size analyzer, a transmission electron microscope (TEM) image, and/or a scanning electron microscope (SEM) image. In one or more embodiments, a dynamic light-scattering measurement device is used to perform a data analysis, the number of particles is counted for each particle size range, and then from this, an average particle diameter (D₅₀) value may be obtained through a calculation. In some embodiments, a laser scattering method may be utilized to measure the average particle diameter (D₅₀). In the laser scattering method, a target particle is distributed in a dispersion solvent, introduced into a laser scattering particle measurement device (e.g., MT3000 commercially available from Microtrac), irradiated with ultrasonic waves of 28 kHz at a power of 60 W, and then an average particle diameter (D₅₀) is calculated in the 50% standard of particle diameter distribution in the measurement device. In the present specification, when particles are spherical, “diameter” indicates a particle diameter, and when the particles are non-spherical, the “diameter” indicates a major axis length.

Spatially relative terms, such as “beneath,” “below,” “lower,” “above,” “upper,” “bottom,” “top” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” or “over” the other elements or features. Thus, the term “below” may encompass both an orientation of above and below. The device may be otherwise oriented (rotated 90 degrees or at other orientations), and the spatially relative descriptors used herein should be interpreted accordingly.

As used herein, the terms “substantially”, “about”, and similar terms are used as terms of approximation and not as terms of degree, and are intended to account for the inherent deviations in measured or calculated values that would be recognized by those of ordinary skill in the art. “About” or “approximately,” as used herein, is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” may mean within one or more standard deviations, or within ±30%, 20%, 10%, 5% of the stated value.

Any numerical range recited herein is intended to include all sub-ranges of the same numerical precision subsumed within the recited range. For example, a range of “1.0 to 10.0” is intended to include all subranges between (and including) the recited minimum value of 1.0 and the recited maximum value of 10.0, that is, having a minimum value equal to or greater than 1.0 and a maximum value equal to or less than 10.0, such as, for example, 2.4 to 7.6. Any maximum numerical limitation recited herein is intended to include all lower numerical limitations subsumed therein and any minimum numerical limitation recited in this specification is intended to include all higher numerical limitations subsumed therein. Accordingly, Applicant reserves the right to amend this specification, including the claims, to expressly recite any sub-range subsumed within the ranges expressly recited herein.

Any relevant electronic devices, devices for manufacturing the same, or components according to embodiments of the present disclosure described herein may be implemented utilizing any suitable hardware, firmware (e.g. an application-specific integrated circuit), software, or a combination of software, firmware, and hardware. For example, the various components of the device may be formed on one integrated circuit (IC) chip or on separate IC chips. Further, the various components of the device may be implemented on a flexible printed circuit film, a tape carrier package (TCP), a printed circuit board (PCB), or formed on one substrate. Further, the various components of the device may be a process or thread, running on one or more processors, in one or more computing devices, executing computer program instructions and interacting with other system components for performing the various functionalities described herein. The computer program instructions are stored in a memory which may be implemented in a computing device using a standard memory device, such as, for example, a random access memory (RAM). The computer program instructions may also be stored in other non-transitory computer readable media such as, for example, a CD-ROM, flash drive, or the like. Also, a person of skill in the art should recognize that the functionality of various computing devices may be combined or integrated into a single computing device, or the functionality of a particular computing device may be distributed across one or more other computing devices without departing from the scope of the embodiments of the present disclosure.

A person of ordinary skill in the art would appreciate, in view of the present disclosure in its entirety, would appreciate that each suitable feature of the various embodiments of the present disclosure may be combined or combined with each other, partially or entirely, and may be technically interlocked and operated in various suitable ways, and each embodiment may be implemented independently of each other or in conjunction with each other in any suitable manner unless otherwise stated or implied.

In this description, unless otherwise separately defined, the term “substituted” may refer to at least one hydrogen of a substituent or a compound being substituted by deuterium, a halogen group, a hydroxyl group, an amino group, a C1 to C30 amine group, a nitro group, a C1 to C40 silyl group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, C1 to C20 alkoxy group, a C1 to C10 fluoroalkyl group, a cyano group, and/or a (e.g., any suitable) combination thereof.

In more detail, the term “substituted” may refer to at least one hydrogen of a substituent or a compound being substituted by deuterium, a halogen group, a C1 to C30 alkyl group, a C1 to C10 alkylsilyl group, a C6 to C30 arylsilyl group, a C3 to C30 cycloalkyl group, a C3 to C30 heterocycloalkyl group, a C6 to C30 aryl group, a C2 to C30 heteroaryl group, a C1 to C10 fluoroalkyl group, or a cyano group. For example, the term “substituted” may refer to at least one hydrogen of a substituent or a compound being substituted by deuterium, a halogen group, a C1 to C20 alkyl group, a C6 to C30 aryl group, a C1 to C10 fluoroalkyl group, or a cyano group. In one or more embodiments, the term “substituted” may refer to at least one hydrogen of a substituent or a compound being substituted by deuterium, a halogen group, a C1 to C5 alkyl group, a C6 to C18 aryl group, a C1 to C5 fluoroalkyl group, or a cyano group. For example, the term “substituted” may refer to at least one hydrogen of a substituent or a compound being substituted by deuterium, a cyano group, a halogen group, a methyl group, an ethyl group, a propyl group, a butyl group, a phenyl group, a biphenyl group, a terphenyl group, a trifluoromethyl group, or a naphthyl group.

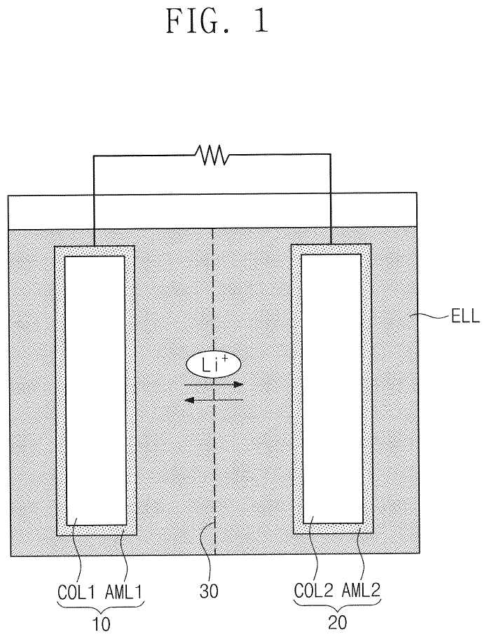

FIG. 1 illustrates a simplified conceptual diagram showing a rechargeable lithium battery according to one or more embodiments of the present disclosure. Referring to FIG. 1, a rechargeable lithium battery may include a positive electrode 10, a negative electrode 20, a separator 30, and an electrolyte ELL.

The positive electrode 10 and the negative electrode 20 may be spaced and/or apart (e.g., spaced apart or separated) from each other across the separator 30. The separator 30 may be arranged between the positive electrode 10 and the negative electrode 20. The positive electrode 10, the negative electrode 20, and the separator 30 may be in contact with the electrolyte ELL. The positive electrode 10, the negative electrode 20, and the separator 30 may be impregnated with the electrolyte ELL.

The electrolyte ELL may be a medium by which lithium ions are transferred between the positive electrode 10 and the negative electrode 20. In the electrolyte ELL, the lithium ions may move through the separator 30 toward one of the positive electrode 10 or the negative electrode 20.

### Positive Electrode 10

The positive electrode 10 for a rechargeable lithium battery may include a current collector COL1 and a positive electrode active material layer AML1 formed on the current collector COL1. The positive electrode active material layer AML1 may include a positive electrode active material and further include a binder and/or a conductive material (e.g., an electron conductor).

An amount of the positive electrode active material may be about 90 wt % to about 99.5 wt % relative to 100 wt % of the positive electrode active material layer AML1. An amount of each of the binder and the conductive material may be about 0.5 wt % to about 5 wt % relative to 100 wt % of the positive electrode active material layer AML1.

The binder may serve to improve attachment of positive electrode active material particles to each other and also to improve attachment of the positive electrode active material to the current collector COL1. The binder may include, for example, polyvinyl alcohol, carboxymethyl cellulose, hydroxypropyl cellulose, diacetyl cellulose, polyvinylchloride, carboxylated polyvinylchloride, polyvinylfluoride, ethylene oxide-containing polymer, polyvinylpyrrolidone, polyurethane, polytetrafluoroethylene, polyvinylidene fluoride, polyethylene, polypropylene, styrene-butadiene rubber, (meth)acrylated styrene-butadiene rubber, epoxy resin, (meth)acrylic resin, polyester resin, and/or nylon, but the present disclosure is not limited thereto.

The conductive material may be used to provide an electrode with conductivity (e.g., to improve electrode conductivity), and any suitable conductive material that does not cause an undesirable chemical change in a battery may be used as the conductive material. The conductive material may include, for example, a carbon-based material such as natural graphite, artificial graphite, carbon black, acetylene black, Ketjen black, carbon fiber, carbon nano-fiber, and/or carbon nano-tube; a metal powder and/or metal fiber containing one or more selected from among copper, nickel, aluminum, and silver; a conductive polymer such as a polyphenylene derivative; and/or a (e.g., any suitable) mixture thereof.

Aluminum (Al) may be used as the current collector COL1, but the present disclosure is not limited thereto.

### Positive Electrode Active Material

The positive electrode active material in the positive electrode active material layer AML1 may include a compound (e.g., lithiated intercalation compound) that can reversibly intercalate and deintercalate lithium (e.g., lithium ions). For example, the positive electrode active material may include at least one kind of composite oxide including lithium and metal that is selected from among cobalt, manganese, nickel, and/or a (e.g., any suitable) combination thereof.

The composite oxide may include lithium transition metal composite oxide, for example, lithium-nickel-based oxide, lithium-cobalt-based oxide, lithium-manganese-based oxide, lithium-iron-phosphate-based compounds, cobalt-free nickel-manganese-based oxide, and/or a (e.g., any suitable) combination thereof.

For example, the positive electrode active material may include a compound represented (e.g., expressed) by one of the (e.g., at least one selected from among) following chemical formulae: LiₐA_{1-b}X_{b}O_{2-c}D_{c} (where 0.90≤a≤1.8, 0≤b≤0.5, and 0≤c≤0.05); LiₐMn_{2-b}X_{b}O_{4-c}D_{c} (where 0.90≤a≤1.8, 0≤b≤0.5, and 0≤c≤0.05); LiₐNi_{1-b-c}Co_{b}X_{c}O_{2-α}D_{α} (where 0.90≤a≤1.8, 0≤b≤0.5, 0≤c≤0.5, and 0<α<2); LiₐNi_{1-b-c}Mn_{b}X_{c}O_{2-α}D_{α} (where 0.90≤a≤1.8, 0≤b≤0.5, 0≤c≤0.5, and 0<α<2); LiₐNi_{b}Co_{c}L¹_{d}GₑO₂ (where 0.90≤a≤1.8, 0≤b≤0.9, 0≤c≤0.5, 0≤d≤0.5, and 0≤e≤0.1); LiₐNiG_{b}O₂ (where 0.90≤a≤1.8 and 0.001≤b≤0.1); LiₐCoG_{b}O₂ (where 0.90≤a≤1.8 and 0.001≤b≤0.1); LiₐMn_{1-b}G_{b}O₂ (where 0.90≤a≤1.8 and 0.001≤b≤0.1); LiₐMn₂G_{b}O₄ (where 0.90≤a≤1.8 and 0.001≤b≤0.1); LiₐMn_{1-g}G_{g}PO₄ (where 0.90≤a≤1.8 and 0≤g≤0.5); Li_{(3-f)}Fe₂(PO₄)₃ (where 0≤f≤2); LiₐFePO₄ (where 0.90≤a≤1.8).

In the chemical formulae above, A may be Ni, Co, Mn, and/or a (e.g., any suitable) combination thereof, X may be Al, Ni, Co, Mn, Cr, Fe, Mg, Sr, V, a rare-earth element, and/or a (e.g., any suitable) combination thereof, D may be O, F, S, P, and/or a (e.g., any suitable) combination thereof, G may be Al, Cr, Mn, Fe, Mg, La, Ce, Sr, V, and/or a (e.g., any suitable) combination thereof, and L¹ may be Mn, Al, and/or a (e.g., any suitable) combination thereof.

For example, the positive electrode active material may be a high-nickel-based positive electrode active material having a nickel amount of equal to or greater than about 80 mol %, about 85 mol %, about 90 mol %, about 91 mol %, or about 94 mol % and equal to or less than about 99 mol %, relative to 100 mol % of metals devoid of lithium in lithium (e.g., metals excluding lithium) in the transition metal composite oxide. The high-nickel-based positive electrode active material may achieve suitably high capacity and thus may be applied to a high-capacity and high-density rechargeable lithium battery. For example, the positive electrode active material may be a high-nickel-based material with a nickel content ranging from 80 mol % to 99 mol % (excluding lithium). This high-nickel composition allows for high capacity, making it suitable for high-capacity and high-density rechargeable lithium batteries.

### Negative Electrode 20

The negative electrode 20 for a rechargeable lithium battery may include a current collector COL2 and a negative electrode active material layer AML2 positioned on the current collector COL2. The negative electrode active material layer AML2 may include a negative electrode active material and may further include a binder and/or a conductive material (e.g., electron conductor).

For example, the negative electrode active material layer AML2 may include a negative electrode active material of about 90 wt % to about 99 wt %, a binder of about 0.5 wt % to about 5 wt %, and a conductive material of about 0 wt % to about 5 wt %, relative to 100 wt % of the negative electrode active material layer AML2.

The binder may serve to improve attachment of negative electrode active material particles to each other and also to improve attachment of the negative electrode active material to the current collector COL2. The binder may include a non-aqueous binder, an aqueous binder, a dry binder, and/or a (e.g., any suitable) combination thereof.

The non-aqueous binder may include polyvinyl chloride, carboxylated polyvinyl chloride, polyvinyl fluoride, ethylene propylene copolymer, polystyrene, polyurethane, polytetrafluoroethylene, polyvinylidene fluoride, polyethylene, polypropylene, polyamide imide, polyimide, and/or a (e.g., any suitable) combination thereof.

The aqueous binder may include styrene-butadiene rubber, (meth)acrylated styrene-butadiene rubber, (meth)acrylonitrile-butadiene rubber, (meth)acrylic rubber, butyl rubber, fluoro elastomer, polyethylene oxide, polyvinyl pyrrolidone, polyepichlorohydrin, polyphosphazene, poly(meth)acrylonitrile, ethylene propylene diene copolymer, polyvinyl pyridine, chlorosulfonated polyethylene, latex, polyester resin, (meth)acrylic resin, phenolic resin, epoxy resin, polyvinyl alcohol, and/or a (e.g., any suitable) combination thereof.

When an aqueous binder is used as the negative electrode binder, a cellulose-based compound capable of providing viscosity may further be included. The cellulose-based compound may include one or more selected from among carboxymethyl cellulose, hydroxypropylmethyl cellulose, methyl cellulose, and alkali metal salts thereof. The alkali metal may include Na, K, and/or Li.

The dry binder may include a fibrillizable polymer material, for example, polytetrafluoroethylene, polyvinylidene fluoride, polyvinylidene fluoride-hexafluoropropylene copolymer, polyethylene oxide, and/or a (e.g., any suitable) combination thereof.

The conductive material may be used to provide an electrode with suitable conductivity (e.g., to improve electrode conductivity), and any suitable conductive material that does not cause an undesirable chemical change in a battery may be used as the conductive material. For example, the conductive material may include a carbon-based material such as natural graphite, artificial graphite, carbon black, acetylene black, Ketjen black, carbon fiber, carbon nano-fiber, and/or carbon nano-tube; a metal powder and/or metal fiber including one or more selected from among copper, nickel, aluminum, and silver; a conductive polymer such as a polyphenylene derivative; and/or a (e.g., any suitable) mixture thereof.

The current collector COL2 may include a copper foil, a nickel foil, a stainless-steel foil, a titanium foil, a nickel foam, a copper foam, a polymer substrate coated with a conductive metal, and/or a (e.g., any suitable) combination thereof.

### Negative Electrode Active Material

The negative electrode active material in the negative electrode active material layer AML2 may include a material that can reversibly intercalate and deintercalate lithium ions, lithium metal, a lithium metal alloy, a material that can dope and de-dope lithium, and/or a transition metal oxide.

The material that can reversibly intercalate and deintercalate lithium ions may include a carbon-based negative electrode active material, for example, crystalline carbon, amorphous carbon, and/or a (e.g., any suitable) combination thereof. For example, the crystalline carbon may include graphite such as non-shaped (e.g., having a random shape), sheet-shaped, flake-shaped, sphere-shaped, and/or fiber-shaped natural and/or artificial graphite, and the amorphous carbon may include soft carbon, hard carbon, mesophase pitch carbon, and/or calcined coke.

The lithium metal alloy may include an alloy of lithium and metal that is selected from among Na, K, Rb, Cs, Fr, Be, Mg, Ca, Sr, Si, Sb, Pb, In, Zn, Ba, Ra, Ge, Al, and Sn.

The material that can dope and de-dope lithium may include a Si-based negative electrode active material and/or a Sn-based negative electrode active material. The Si-based negative electrode active material may include silicon, silicon-carbon composite, SiOₓ (where 0<x≤2), Si-Q alloy (where Q is alkali metal, alkaline earth metal, Group 13 element, Group 14 element (except for Si), Group 15 element, Group 16 element, transition metal, a rare-earth element, and/or a (e.g., any suitable) combination thereof), and/or a (e.g., any suitable) combination thereof. The Sn-based negative electrode active material may include Sn, SnOₓ (where 0<x≤2, e.g., SnO₂), a Sn-based alloy, and/or a (e.g., any suitable) combination thereof.

The silicon-carbon composite may be a composite of silicon and amorphous carbon. According to one or more embodiments, the silicon-carbon composite may have a structure in which the amorphous carbon is coated on a surface of the silicon particle. For example, the silicon-carbon composite may include a secondary particle (core) in which primary silicon particles are assembled, and an amorphous carbon coating layer (shell) positioned on a surface of the secondary particle. The amorphous carbon may also be positioned between the primary silicon particles, and for example, the primary silicon particles may be coated with the amorphous carbon. The secondary particles may be dispersed in an amorphous carbon matrix.

The silicon-carbon composite may further include crystalline carbon. For example, the silicon-carbon composite may include a core including crystalline carbon and silicon particles and may also include an amorphous carbon coating layer positioned on a surface of the core.

The Si-based negative electrode active material and/or the Sn-based negative electrode active material may be used in combination with a carbon-based negative electrode active material.

### Separator 30

Based on a type (kind) of the rechargeable lithium battery, the separator 30 may be present between positive electrode 10 and the negative electrode 20. The separator 30 may include one or more selected from among polyethylene, polypropylene, and polyvinylidene fluoride, and may have a multi-layered separator thereof such as a polyethylene/polypropylene bi-layered separator, a polyethylene/polypropylene/polyethylene tri-layered separator, and/or a polypropylene/polyethylene/polypropylene tri-layered separator.

The separator 30 may include a porous substrate and a coating layer positioned on one surface or both (e.g., opposite) surfaces of the porous substrate, where the coating layer may include an organic material, an inorganic material, and/or a (e.g., any suitable) combination thereof.

The porous substrate may be a polymer layer including one selected from among polyolefin such as polyethylene and/or polypropylene, polyester such as polyethylene terephthalate (e.g., Teflon™) and/or polybutylene terephthalate, polyacetal, polyamide, polyimide, polycarbonate, polyetherketone, polyaryletherketone, polyetherimide, polyamideimide, polybenzimidazole, polyethersulfone, polyphenyleneoxide, cyclic olefin copolymer, polyphenylenesulfide, polyethylene naphthalate, glass fiber, and polytetrafluoroethylene, or may be a copolymer and/or mixture including two or more of the materials mentioned above.

The organic material may include a polyvinylidene fluoride-based copolymer and/or a (meth)acrylic copolymer.

The inorganic material may include an inorganic particle selected from among Al₂O₃, SiO₂, TiO₂, SnO₂, CeO₂, MgO, NiO, CaO, GaO, ZnO, ZrO₂, Y₂O₃, SrTiO₃, BaTiO₃, Mg(OH)₂, Boehmite, and/or a (e.g., any suitable) combination thereof, but the present disclosure is not limited thereto.

The organic material and the inorganic material may be mixed in one coating layer, or may be present as a stack of a coating layer including the organic material and a coating layer including an inorganic material.

### Electrolyte ELL

The electrolyte ELL for a rechargeable lithium battery may include a non-aqueous organic solvent and a lithium salt.

The non-aqueous organic solvent may serve as a medium for transmitting ions that participate in an electrochemical reaction of the battery.

The non-aqueous organic solvent may include a carbonate-based solvent, an ester-based solvent, an ether-based solvent, a ketone-based solvent, an alcohol-based solvent, an aprotic solvent, and/or a (e.g., any suitable) combination thereof.

The carbonate-based solvent may include dimethyl carbonate (DMC), diethyl carbonate (DEC), dipropyl carbonate (DPC), methylpropyl carbonate (MPC), ethylpropyl carbonate (EPC), methylethyl carbonate (MEC), ethylene carbonate (EC), propylene carbonate (PC), and/or butylene carbonate (BC).

The ester-based solvent may include methyl acetate, ethyl acetate, n-propyl acetate, dimethyl acetate, methyl propionate, ethyl propionate, decanolide, mevalonolactone, valerolactone, caprolactone, and/or propyl propionate (PP).

The ether-based solvent may include dibutyl ether, tetraglyme, diglyme, dimethoxyethane, 2-methyltetrahydrofuran, 2.5-dimethyltetrahydrofuran, and/or tetrahydrofuran. The ketone-based solvent may include cyclohexanone. The alcohol-based solvent may include ethyl alcohol and/or isopropyl alcohol, and the aprotic solvent may include nitriles such as R—CN (where R is a hydrocarbon group having a C2 to C20 linear, branched, or cyclic structure and may include a double bond, an aromatic ring, and/or an ether group); amides such as dimethylformamide; dioxolanes such as 1,3-dioxolane and/or 1.4-dioxolane; and/or sulfolanes.

The non-aqueous organic solvent may be used alone or in a mixture of two or more substances.

In addition, if (e.g., when) a carbonate-based solvent is used, a cyclic carbonate and a linear carbonate may be mixed and used, and the cyclic carbonate and the linear carbonate may be mixed in a volume ratio of about 1:1 to about 1:9.

The lithium salt may be a material that is dissolved in the non-aqueous organic solvent to serve as a supply source of lithium ions in a battery, and may play a role in enabling or facilitating a basic operation of a rechargeable lithium battery and in promoting the movement of lithium ions between positive and negative electrodes. The lithium salt may include, for example, at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂)(C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB)

The following will describe in more detail an electrolyte for a rechargeable lithium battery according to one or more embodiments of the present disclosure.

An electrolyte for a rechargeable lithium battery according to one or more embodiments may include a non-aqueous organic solvent, a lithium salt, and an additive, and the additive may include a cyclic carbonate-based compound including an azide-containing group.

The additive will be further discussed in more detail herein below.

The electrolyte may be prepared by a mixing process in which the lithium salt is dissolved in the non-aqueous organic solvent and the additive is added to mixture. Any suitable electrolyte mixing process in electrolyte fabrication field may be utilized, and a person skilled in the art should be able to select and apply the suitable process.

In one or more embodiments, the non-aqueous organic solvent may include a cyclic carbonate-based solvent. The cyclic carbonate-based solvent may include ethylene carbonate (EC), propylene carbonate (PC), butylene carbonate (BC), vinylene carbonate (VC), and/or vinylethylene carbonate (VEC), but the present disclosure is not limited thereto. The cyclic carbonate-based solvent may be present in an amount of about 5 parts by volume to about 50 parts by volume relative to 100 parts by volume of the non-aqueous organic solvent. In one or more embodiments, the cyclic carbonate-based solvent may be present in an amount of about 10 parts by volume to about 30 parts by volume relative to 100 parts by volume of the non-aqueous organic solvent.

In one or more embodiments, the non-aqueous organic solvent may include a linear carbonate-based solvent and a cyclic carbonate-based solvent. The linear carbonate-based solvent may include, for example, dimethyl carbonate (DMC), diethyl carbonate (DEC), dipropyl carbonate (DPC), methylpropyl carbonate (MPC), ethylpropyl carbonate (EPC), and/or ethylmethyl carbonate (EMC), but the present disclosure is not limited thereto. A volume ratio of the linear carbonate-based solvent and the cyclic carbonate-based solvent may range from about 50:50 and about 95:5. In one or more embodiments, a volume ratio of the linear carbonate-based solvent and the cyclic carbonate-based solvent may range from about 70:30 to about 90:10.

In one or more embodiments, the non-aqueous organic solvent may include a linear ester-based solvent, a linear carbonate-based solvent, and a cyclic carbonate-based solvent. The linear ester-based solvent may include methyl acetate, ethyl acetate, n-propyl acetate, dimethyl acetate, methyl propionate, ethyl propionate, and/or propyl propionate (PP), but the present disclosure is not limited thereto. A value of “A” may be defined to refer to a sum of volume of the linear ester-based solvent and volume of the linear carbonate-based solvent. A value of “B” may be defined to refer to a volume of the cyclic carbonate-based solvent. A ratio of A to B (or A:B) may range from about 50:50 to about 95:5. In one or more embodiments, a ratio of A to B (or A:B) may range from about 70:30 to about 90:10.

When the type (kind) and volume ratio of the organic solvent are satisfied, the additive may appropriately or suitably maintain its solubility. The embodiments described herein, however, are merely examples of the present disclosure, and the present disclosure is not limited thereto.

In one or more embodiments, the lithium salt may include at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

The lithium salt may have a concentration of about 0.1 M to about 2.0 M. For example, the lithium salt may have a concentration of equal to or greater than about 0.5 M or equal to or greater than about 1.0 M. The lithium salt may have a concentration of equal to or less than about 2.0 M, equal to or less than about 1.7 M, or equal to or less than about 1.5 M. If (e.g., when) the lithium salt has a concentration of about 0.1 M to about 2.0 M, the electrolyte may appropriately or suitably maintain its conductivity and viscosity.

### Additive

The additive according to the present disclosure may include a cyclic carbonate-based compound including an azide-containing group.

The cyclic carbonate-based compound may be represented by Chemical Formula 1 or Chemical Formula 2.

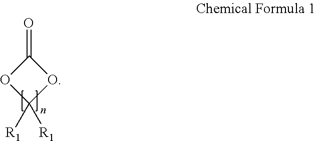

In Chemical Formula 1,

The subscript n may be an integer of 2 to 5.

R₁ may be hydrogen, a substituted or unsubstituted C1 to C10 alkyl group, a substituted or unsubstituted C2 to C10 alkenyl group, a substituted or unsubstituted C2 to C10 alkynyl group, or the azide-containing group.

R₁ groups may be substantially identical to or different from each other.

At least one of R₁ groups may be the azide-containing group.

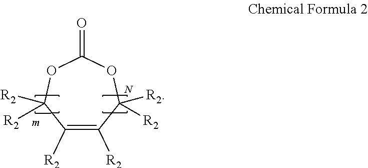

In Chemical Formula 2,

The subscript m may be an integer of 0 to 3.

The subscript z may be an integer of 0 to 3.

A sum of m and z may be an integer of equal to or less than 3.

R₂ may be hydrogen, a substituted or unsubstituted C1 to C10 alkyl group, a substituted or unsubstituted C2 to C10 alkenyl group, a substituted or unsubstituted C2 to C10 alkynyl group, or the azide-containing group.

R₂ groups may be substantially identical to or different from each other.

At least one of R₂ groups may be the azide-containing group.

The azide-containing group may be an azide group or a substituted or unsubstituted C1 to C4 alkyl azide group.

The alkyl azide group may be represented by —R—N₃. The alkyl azide group may include methyl azide, ethyl azide, n-propyl azide, and/or isopropyl azide, but the present disclosure is not limited thereto.

In one or more embodiments, if (e.g., when) n is 2 in Chemical Formula 1, the compound may be ethylene carbonate (EC) including four R₁. Four R₁ may be substantially identical or different. At least one of four R₁ may be the azide-containing group.

In one or more embodiments, if (e.g., when) m and z are each 0 in Chemical Formula 2, the compound may be vinylene carbonate (VC) including two R₂. Two R₂ may be substantially identical or different. At least one of two R₂ may be the azide-containing group.

In one or more embodiments, n may be 2 or 3, and a sum of m and z may be an integer of equal or less than 1. For example, a ring portion of the compound of Chemical Formula 2 may be pentagonal or hexagonal.

In one or more embodiments, may be 2, and m and z may each be 0. For example, a ring portion of the compound may be pentagonal.

In one or more embodiments, R₁ may be hydrogen, a substituted or unsubstituted C1 to C5 alkyl group, a substituted or unsubstituted C2 to C5 alkenyl group, a substituted or unsubstituted C2 to C5 alkynyl group, or the azide-containing group. R₂ may be hydrogen, a substituted or unsubstituted C1 to C5 alkyl group, a substituted or unsubstituted C2 to C5 alkenyl group, a substituted or unsubstituted C2 to C5 alkynyl group, or the azide-containing group.

For example, R₁ may be hydrogen or the azide-containing group, and R₂ may be hydrogen or the azide-containing group.

In one or more embodiments, the compound may be represented by Chemical Formula 1-1 or Chemical Formula 2-1.

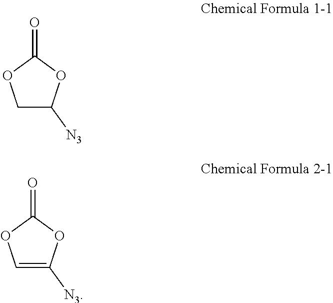 [SMILES: [N-]=[N+]=NC1COC(=O)O1 ; [N-]=[N+]=Nc1coc(=O)o1]

In one or more embodiments, the compound may be represented by Chemical Formula 1-2:

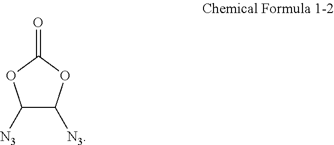 [SMILES: [N-]=[N+]=NC1OC(=O)OC1N=[N+]=[N-]]

The additive may be present in an amount of about 0.01 parts by weight to about 5 parts by weight relative to 100 parts by weight of the electrolyte. For example, the additive may be present in an amount of about 0.01 parts by weight to about 3 parts by weight relative to 100 parts by weight of the electrolyte. For another example, the additive may be present in an amount of about 0.01 parts by weight to about 1 part by weight relative to 100 parts by weight of the electrolyte. The amount of the additive may refer to a weight of the additive included in the electrolyte relative to the total weight of the electrolyte. If (e.g., when) the amount of the additive falls within any of the ranges above, it may be possible to maximize or increase an effect of improving battery performance at high voltages and high temperatures.

In the cyclic carbonate-based compound, the azide-containing group may be dissociated from a cyclic structure (cyclic moiety) including carbonate to form a LiN-based inorganic component film on a positive electrode. The LiN-based inorganic component film may be a film including, for example, Li₃N and/or LiNₓO_{y}. The film may prevent or reduce additional oxidation of the positive electrode, thereby improving battery performance.

After the dissociation of the azide-containing group, a residual cyclic carbonate-based compound may serve as an organic solvent in the electrolyte. The residual cyclic carbonate-based compound may be, for example, ethylene carbonate (EC) and/or vinylene carbonate (VC). A repetition of charge and discharge of the battery may damage a solid electrolyte interface (SEI) of a negative electrode. An organic solvent in the electrolyte may serve to regenerate the damaged SEI. The repeated damage and regeneration of the SEI may induce depletion of the electrolyte, and this may lead to a reduction in battery lifespan and performance. The residual cyclic carbonate-based compound may have an effect of continuously supplementing the depleted organic solvent.

Due to the structural characteristics of the compound, the additive according to the present disclosure may provide a protective effect for the positive electrode and the negative electrode as the additive undergoes a reaction. Accordingly, the battery may undergo substantially continuous self-healing. In other words, the additive may help form a protective film on the positive electrode, as well as assist in supplementation of the organic solvent, thus facilitating regeneration of the damaged SEI during the charging and discharging of the lithium battery.

A degradation in the positive electrode and the negative electrode may proceed more rapidly at high temperatures. Therefore, the self-healing effect of the additive according to the present disclosure may become more pronounced at high temperatures. The high temperatures may be equal to or greater than about 40° C., 50° C., or 60° C.

### Rechargeable Lithium Battery

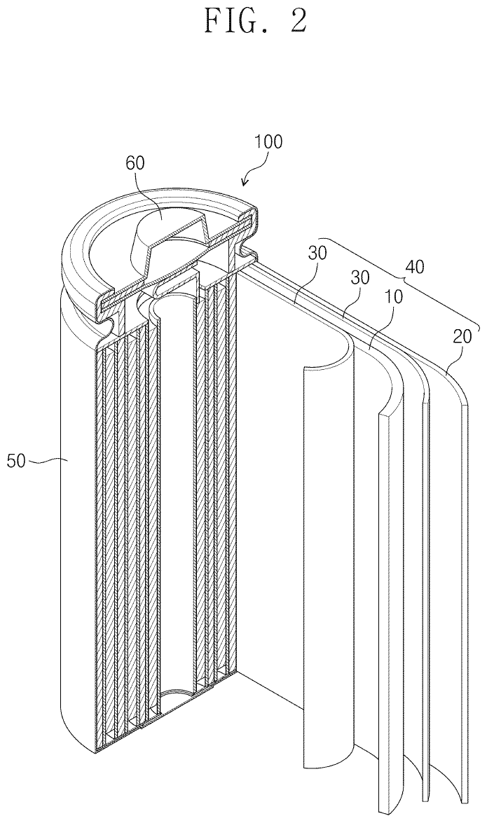

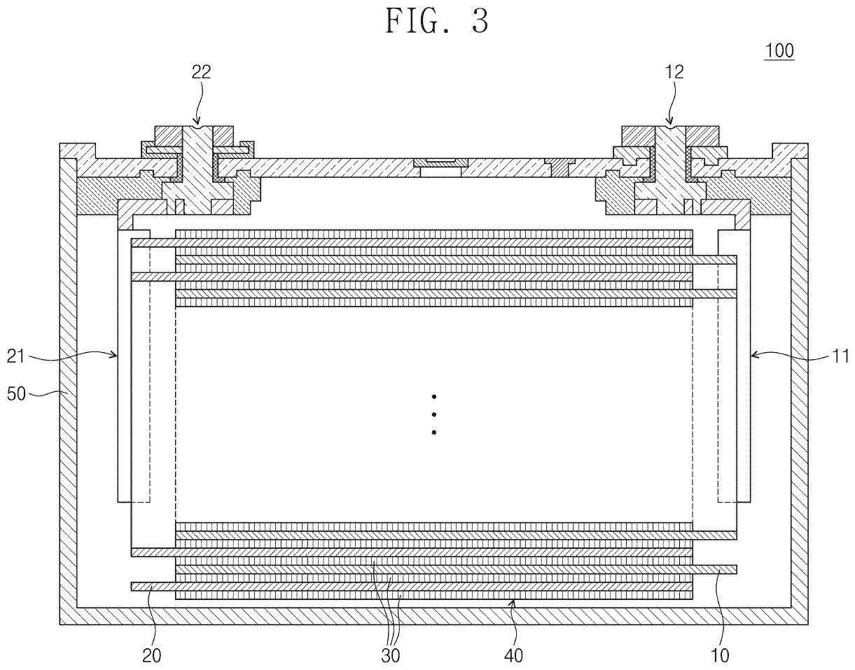

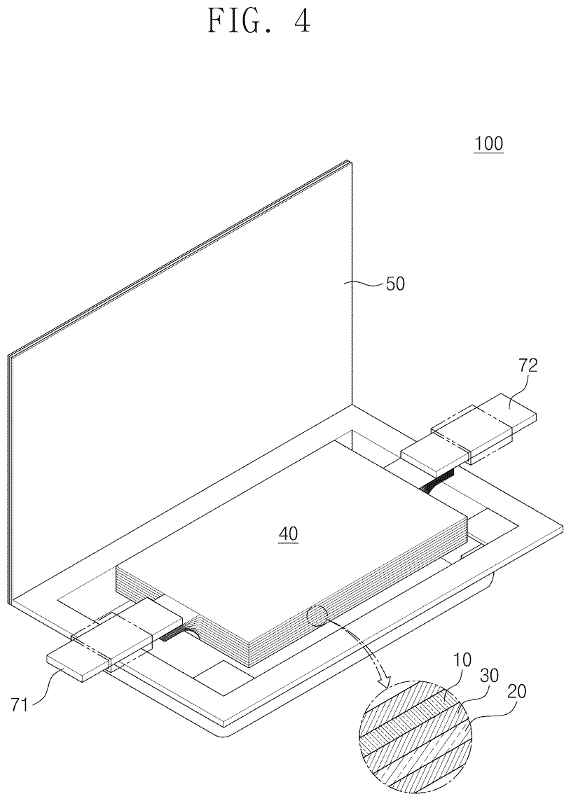

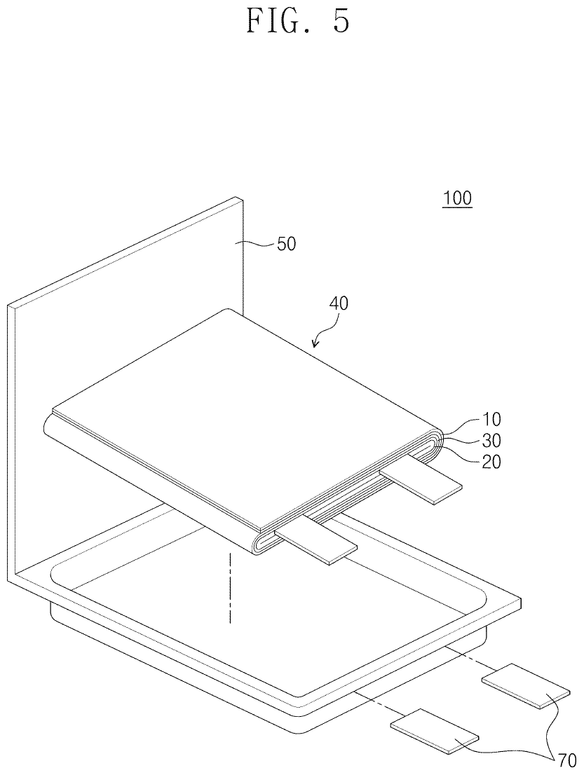

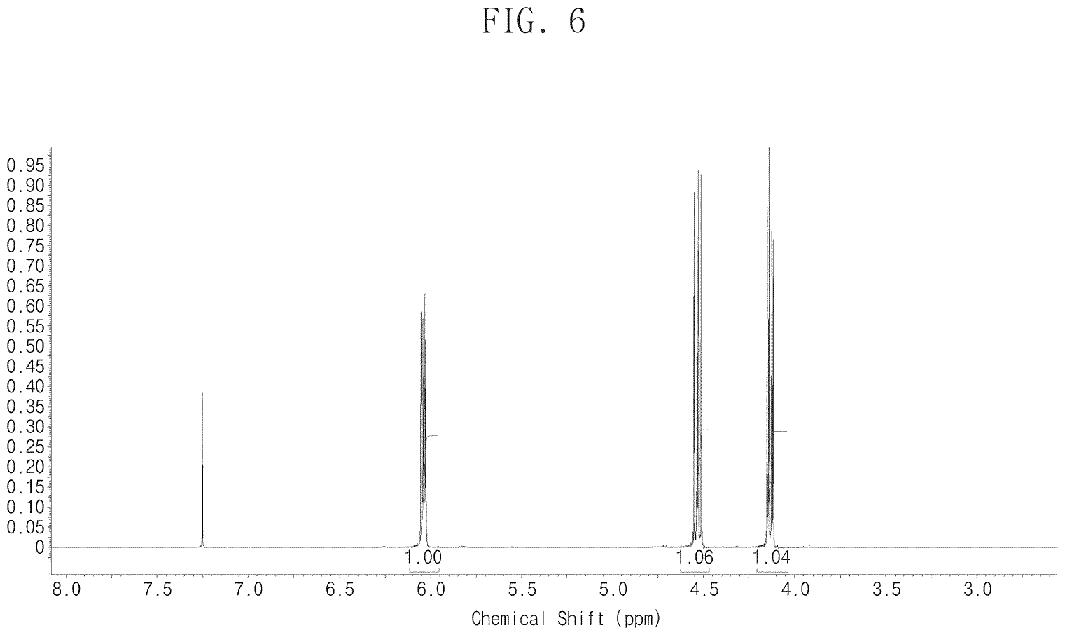

Based on a shape of a rechargeable lithium battery, the rechargeable lithium battery may be classified into cylindrical, prismatic, pouch, and/or coin types (kinds). FIGS. 2 to 5 illustrate simplified diagrams each showing a rechargeable lithium battery according to one or more embodiments, with FIG. 2 showing a cylindrical battery, FIG. 3 showing a prismatic battery, and FIGS. 4 and 5 showing pouch-type (kind) batteries. Referring to FIGS. 2 to 4, a rechargeable lithium battery 100 may include an electrode assembly 40 in which a separator 30 is interposed between a positive electrode 10 and a negative electrode 20, and may also include a casing 50 in which the electrode assembly 40 is accommodated. The positive electrode 10, the negative electrode 20, and the separator 30 may be impregnated with an electrolyte. The rechargeable lithium battery 100 may include a sealing member 60 that seals the casing 50 as illustrated in FIG. 2. In addition, as illustrated in FIG. 3, the rechargeable lithium battery 100 may include a positive electrode lead tab 11, a positive electrode terminal 12, a negative electrode lead tab 21, and a negative electrode terminal 22. As shown in FIGS. 4 and 5, the rechargeable lithium battery 100 may include an electrode tab 70, or a positive electrode tab 71 and a negative electrode tab 72, where the electrode tab 70 may serve as an electrical path for externally inducing a current generated in the electrode assembly 40.

The rechargeable lithium battery according to one or more embodiments of the present disclosure may be applied to automotive vehicles, mobile phones, and/or any other electrical devices, but the present disclosure is not limited thereto. For example, the rechargeable lithium battery may be utilized as power storage power source for home power storage units and/or power walls (e.g., it may serve as a power storage source for energy storage systems (ESS)), as well as a driving power source for hybrid or electric vehicles (automotive battery).

A rechargeable lithium battery according to the present disclosure may include a positive electrode including a positive electrode active material, a negative electrode including a negative electrode active material, and the electrolyte for the rechargeable lithium battery according to the present embodiments.

The positive electrode active material may include lithium composite oxide represented by Chemical Formula 3.

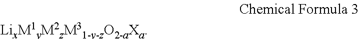

The subscripts x, a, y, and z may satisfy the following relationships: 0.5≤x≤1.8, 0≤a≤0.05, 0<y≤1, 0≤z≤1, and 0≤y+z≤1.

M¹, M², and M³ may each independently include at least one element selected from among metals such as Ni, Co, Mn, Al, B, Ba, Ca, Ce, Cr, Fe, Mo, Nb, Si, Sr, Mg, Ti, V, W, Zr, La, and/or a (e.g., any suitable) combination thereof.

X may include at least one element selected from among F, S, P, and Cl.

In one or more embodiments, in Chemical Formula 3, M¹ may be Ni. For example, in Chemical Formula 3, M¹ may be Ni, M² may be Co, and M³ may be Al. For example, the positive electrode active material may include an NCA (nickel cobalt aluminum)-based positive electrode active material.

A positive electrode active material containing Ni may have significant (e.g., relatively strong) side reactions with the electrolyte because of inherent instability of the Ni element. Therefore, the battery stabilization effect of the additive according to the present disclosure may be more pronounced in the positive electrode active material. However, there is no limitation on the type (kind) of the positive electrode active material included in the battery according to the present disclosure.

The negative electrode active material may be a carbon-based negative electrode active material, a Si-based negative electrode active material, a Sn-based negative electrode active material, and/or a (e.g., any suitable) combination thereof.

In one or more embodiments, the negative electrode active material may be a silicon-carbon composite.

The following will describe some examples and comparative examples of the present disclosure. The following embodiments, however, are merely examples, and the present disclosure is not limited to one or more embodiments discussed herein below.

### Synthesis Example 1

75 mmol of chloroethylene carbonate and 120 mL of acetone were added to and agitated in a round-bottom flask. 375 mmol of sodium azide was added to and completely dissolved in 120 mL of distilled water.

The dissolved distilled water mixture was gradually added dropwise to a mixed solution of chloroethylene carbonate and acetone. Agitation was executed for 3 hours at room temperature to terminate the reaction.

Extraction was executed three times with ethyl acetate and distilled water. An ethyl acetate layer was treated with MgSO₄ and then concentrated. The reaction mixture was concentrated and then vacuum-dried to obtain a compound represented by Chemical Formula 1-1.

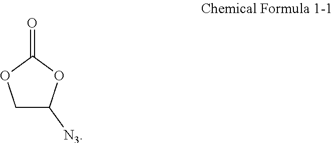

### Synthesis Example 2

81 mmol of 4-chloro-1,3-dioxol-2-one and 150 mL of acetone were added to and agitated in a round-bottom flask. 405 mmol of sodium azide was added to and completely dissolved in 150 ml of distilled water.

The dissolved distilled water mixture was gradually added dropwise to a mixed solution of 4-chloro-1,3-dioxol-2-one and acetone. Agitation was executed for 3 hours at room temperature to terminate the reaction.

Extraction was executed three times with ethyl acetate and distilled water. An ethyl acetate layer was treated with MgSO₄ and then concentrated. The reaction mixture was concentrated and then vacuum-dried to obtain a compound represented by Chemical Formula 2-1.

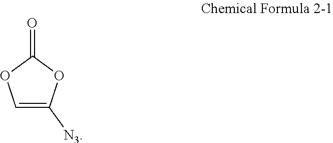

Chemical Formula 2-1 was synthesized as a representative example of Chemical Formula 2, but it was not used in the embodiments.

### Embodiment 1

### (1) Preparation of Electrolyte

1.15 M of LiPF₆ was dissolved in a non-aqueous organic solvent containing ethylene carbonate (EC), ethylmethyl carbonate (EMC), and dimethyl carbonate (DMC) mixed in a volume ratio of about 20:40:40. An electrolyte was prepared by addition of an additive including the compound obtained in Synthesis Example 1. The additive was present in an amount of 0.1 parts by weight relative to 100 parts by weight of the electrolyte.

### (2) Fabrication of Rechargeable Lithium Battery

LiNi_{0.91}Co_{0.07}Al_{0.02}O₂ as a positive electrode active material, polyvinylidene fluoride as a binder, and Ketjen black as a conductive material were mixed in a weight ratio of 97:2:1, and the mixture was dispersed in N-methyl pyrrolidone to prepare a positive electrode active material slurry.

The positive electrode active material slurry was coated on an aluminum current collector of 14 μm in thickness, dried at 110° C., and then pressed to manufacture a positive electrode.

Artificial graphite and silicon nano-particles mixed in a weight ratio of 93:7 as a negative electrode active material, styrene-butadiene rubber (SBR) as a binder, and carboxymethyl cellulose (CMC) as a thickener were mixed in a weight ratio of 97:1:2, and the mixture was dispersed in distilled water to prepare a negative electrode active material slurry.

The negative electrode active material slurry was coated on a copper current collector of 10 μm in thickness, dried at 100° C., and then pressed to manufacture a negative electrode.

The positive electrode, the negative electrode, and a polyethylene separator of 25 μm in thickness were assembled to manufacture an electrode assembly, and the electrolyte was introduced (impregnated) to fabricate a rechargeable lithium battery.

### Embodiment 2

An electrolyte and a rechargeable lithium battery were fabricated in substantially the same method as in Embodiment 1, except that an amount of the additive was 0.5 parts by weight.

### Embodiment 3

An electrolyte and a rechargeable lithium battery were fabricated in substantially the same method as in Embodiment 1, except that an amount of the additive was 1 part by weight.

### Embodiment 4

An electrolyte and a rechargeable lithium battery were fabricated in substantially the same method as in Embodiment 1, except that an amount of the additive was 3 parts by weight.

### Embodiment 5

An electrolyte and a rechargeable lithium battery were fabricated in substantially the same method as in Embodiment 1, except that an amount of the additive was 5 parts by weight.

### Embodiment 6

An electrolyte and a rechargeable lithium battery were fabricated in substantially the same method as in Embodiment 1, except that the compound of Synthesis Example 1 was replaced with a compound represented by Chemical Formula 1-2 and an amount of the additive was 1 part by weight.

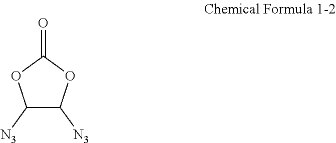 [SMILES: [N-]=[N+]=NC1OC(=O)OC1N=[N+]=[N-]]

### Comparative 1

An electrolyte and a rechargeable lithium battery were fabricated in substantially the same method as in Embodiment 1, except that the electrolyte did not include the compound represented by Synthesis Example 1.

### Evaluation 1: Floating Charge

The positive electrode and the electrolyte of Embodiment 1 were used to fabricate a 2032-type (kind) coin half-cell. A lithium metal counter electrode was used as the negative electrode, and a polyethylene separator was interposed between the positive electrode and the lithium metal counter electrode.

The manufactured coin half-cell was kept at 45° C. while maintaining 4.4 V for 250 hours, and then a current of the battery was measured. A leak current was calculated according to Equation 1. The same evaluation method was applied to Embodiments 2 to 6 and Comparative 1. The results are shown in Table 1.

$$Leak current = current after storage for 250 hours / mass of active material \qquad Equation l$$

### Evaluation 2: Open Circuit Voltage (OCV) During High-Temperature Storage

An electrolyte of Embodiments 1 to 6 and Comparative 1, respectively, a negative electrode of a silicon-carbon composite, and a positive electrode of NCA were used to fabricate 5.8 ampere rated prismatic cell. The rechargeable lithium battery was charged under the condition of 25° C., 0.33 C, 4.25V, and 0.05 C cut-off, and an OCV value of the battery was measured. The rechargeable lithium battery was left at 60° C. for 10 days, and then an OCV value of the battery was measured. The results are shown in Table 1.

### Evaluation 3: High-Temperature Storage

An electrolyte of Embodiments 1 to 6 and Comparative 1, respectively, a negative electrode of a silicon-carbon composite, and a positive electrode of NCA were used to fabricate 5.8 ampere rated prismatic cell. The rechargeable lithium battery was charged under the condition of 25° C., 0.33 C, 4.25V, and 0.05 C cut-off, and initial characteristic values of the battery were measured. The rechargeable lithium battery was left at 60° C. for 60 days, and then characteristic values of the battery were measured. A capacity retention rate and a resistance increase rate were calculated according to Equation 2 and Equation 3, respectively. A current of 1 C was applied for 10 seconds, and dR=dV/dl was used to measure a direct-current internal resistance (DCIR). The results are shown in Table 1.

$$Capacity retention rate ( \% ) = ( discharge capacity afte r 60 days / initial discharge capacity ) \times 100 \qquad Equation 2$$

$$Resistance increase rate ( \% ) = ( DCIR after 60 days / initial DCIR ) \times 100 \qquad Equation 3$$

### Evaluation 4: High-Temperature Lifespan

An electrolyte of Embodiments 1 to 6 and Comparative 1, respectively, a negative electrode of a silicon-carbon composite, and a positive electrode of NCA were used to fabricate 5.8 ampere rated prismatic cell. The rechargeable lithium battery was charged under the condition of 25° C., 0.33 C, 4.25V, and 0.05 C cut-off, and initial characteristic values of the battery were measured. A charge/discharge cycle was performed 100 times at a high temperature (45° C.), and then characteristic values of the battery were measured at 25° C. The charge condition was 45° C., 0.33 C, 4.25V, and 0.05 C cut-off if (e.g., when) the cycle was performed. The discharge condition was 45° C., 0.33 C, and 2.8V cut-off. A capacity retention rate and a resistance increase rate were calculated according to Equation 4 and Equation 5, respectively. A current of 1 C was applied for 10 seconds, and dR=dV/dl was used to measure a direct-current internal resistance (DCIR). The results are shown in Table 1.

$$Capacity retention rate ( \% ) = ( discharge capacity after 100 cycles / \text{} initial \\ discharge capacity ) \times 100 \qquad Equation 4$$

$$Resistance increase rate ( \% ) = ( DCIR after 100 cycles / initial DCIR ) \times 100 \qquad Equation 5$$

TABLE 1

| | | | Evaluation result | | | | | | |
|---|---|---|---|---|---|---|---|---|---|
| | Additive | | | | | Capacity | Resistance | Capacity | Resistance |
| | Chemical | | | | OCV | retention | increase | retention | increase |
| | Formula | | | | after 10 | rate after | rate after | rate after | rate after |
| | [amount] | | Leak | Initial | days at | 60 days | 60 days | 100 | 100 |
| | (part by | | current | OCV | 60° C. | at 60° C. | at 60° C. | cycles | cycles |
| | weight) | | (mA/g) | (V) | (V) | (%) | (%) | (%) | (%) |
| Comparative 1 | — | [—] | 1.8 | 4.40 | 4.31 | 90.8 | 114 | 85.95 | 168.1 |
| Embodiment 1 | 1-1 | [0.1] | 0.61 | 4.40 | 4.37 | 92.5 | 111 | 88.72 | 155.1 |
| Embodiment 2 | 1-1 | [0.5] | 0.58 | 4.40 | 4.38 | 92.4 | 111 | 89.01 | 155.3 |
| Embodiment 3 | 1-1 | [1] | 0.428 | 4.40 | 4.38 | 92.6 | 112 | 89.13 | 156.8 |
| Embodiment 4 | 1-1 | [3] | 0.56 | 4.40 | 4.38 | 92.5 | 112 | 89.44 | 157.9 |
| Embodiment 5 | 1-1 | [5] | 0.7 | 4.40 | 4.38 | 92.0 | 112 | 88.92 | 161.1 |
| Embodiment 6 | 1-2 | [1] | 0.53 | 4.40 | 4.38 | 92.4 | 112 | 89.5 | 158.2 |

Referring to Table 1, it may be observed that, compared to the comparative example, the examples according to the present disclosure exhibited excellent or suitable characteristics in terms of floating charge, OCV, high-temperature storage, and high-temperature lifespan. For example, it may be ascertained that the additive according to the present disclosure has an excellent or suitable effect of improving battery performance at high voltages and high temperatures.

An additive of the present disclosure may have an excellent or suitable effect of improving battery performance at high voltages and high temperatures.

A rechargeable lithium battery including the additive may have superior or improved performance at high voltages and high temperatures.

While this disclosure has been described in connection with what is presently considered to be example embodiments, it is to be understood that the present disclosure is not limited to the disclosed embodiments and is intended to cover one or more suitable modifications and equivalent arrangements included within the spirit and scope of the appended claims and their equivalents, and therefore the aforementioned embodiments should be understood to be examples but not limiting this disclosure in any way.

What is claimed is:

1. An electrolyte comprising:
a non-aqueous organic solvent;
a lithium salt; and
an additive,
wherein the additive comprises a cyclic carbonate-based compound comprising an azide-containing group.

2. The electrolyte as claimed in claim 1, wherein the azide-containing group is an azide group or a substituted or unsubstituted C1 to C4 alkyl azide group.

3. The electrolyte as claimed in claim 1, wherein the cyclic carbonate-based compound is represented by Chemical Formula 1 or Chemical Formula 2: 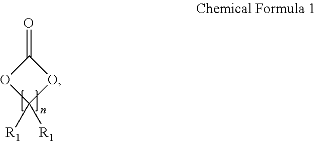
in Chemical Formula 1,
n is an integer of 2 to 5,
R₁(s) are each independently hydrogen, a substituted or unsubstituted C1 to C10 alkyl group, a substituted or unsubstituted C2 to C10 alkenyl group, a substituted or unsubstituted C2 to C10 alkynyl group, or the azide-containing group,
R₁(s) are each independently identical to or different from each other, and
at least one of R₁(s) is the azide-containing group, 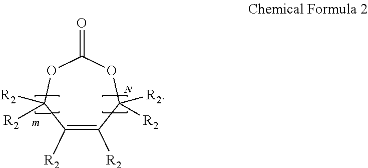
in Chemical Formula 2,
m is an integer of 0 to 3,
z is an integer of 0 to 3,
a sum of m and z is an integer of equal to or less than 3,
R₂(s) are each independently hydrogen, a substituted or unsubstituted C1 to C10 alkyl group, a substituted or unsubstituted C2 to C10 alkenyl group, a substituted or unsubstituted C2 to C10 alkynyl group, or the azide-containing group,
R₂(s) are each independently identical to or different from each other, and
at least one of R₂(s) is the azide-containing group.

4. The electrolyte as claimed in claim 3, wherein
n is 2 or 3, and
a sum of m and z is an integer of equal to or less than 1.

5. The electrolyte as claimed in claim 3, wherein
n is 2, and
m and z are 0.

6. The electrolyte as claimed in claim 3, wherein
R₁(s) are each independently hydrogen, a substituted or unsubstituted C1 to C5 alkyl group, a substituted or unsubstituted C2 to C5 alkenyl group, a substituted or unsubstituted C2 to C5 alkynyl group, or the azide-containing group, and
R₂(s) are each independently hydrogen, a substituted or unsubstituted C1 to C5 alkyl group, a substituted or unsubstituted C2 to C5 alkenyl group, a substituted or unsubstituted C2 to C5 alkynyl group, or the azide-containing group.

7. The electrolyte as claimed in claim 3, wherein
R₁(s) are each independently hydrogen or the azide-containing group, and
R₂(s) are each independently hydrogen or the azide-containing group.

8. The electrolyte as claimed in claim 3, wherein the cyclic carbonate-based compound is represented by Chemical Formula 1-1 or Chemical Formula 2-1,

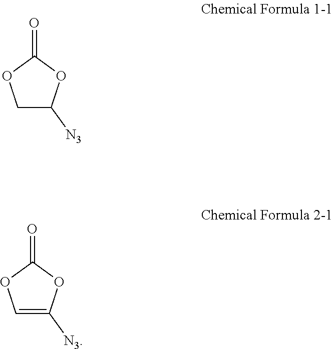 [SMILES: [N-]=[N+]=NC1COC(=O)O1 ; [N-]=[N+]=Nc1coc(=O)o1]

9. The electrolyte as claimed in claim 1, wherein the additive is present in an amount of about 0.01 parts by weight to about 5 parts of weight relative to 100 parts by weight of the electrolyte.

10. The electrolyte as claimed in claim 1, wherein the non-aqueous organic solvent comprises a cyclic carbonate-based solvent, and
wherein the cyclic carbonate-based solvent is present in an amount of about 5 parts by volume to about 50 parts by volume relative to 100 parts by volume of the non-aqueous organic solvent.

11. The electrolyte as claimed in claim 1, wherein the lithium salt comprises at least one selected from among LiPF₆, LiBF₄, LiSbF₆, LiAsF₆, LiClO₄, LiAlO₂, LiAlCl₄, LiPO₂F₂, LiCl, LiI, LiN(SO₃C₂F₅)₂, Li(FSO₂)₂N (lithium bis(fluorosulfonyl)imide, LiFSI), LiC₄F₉SO₃, LiN(CₓF₂ₓ₊₁SO₂) (C_{y}F_{2y+1}SO₂) (where x and y are integers of 1 to 20), lithium trifluoromethane sulfonate, lithium tetrafluoroethanesulfonate, lithium difluoro (oxalato) borate (LiDFOB), lithium difluorobis(oxalato)phosphate (LiDFBOP), and lithium bis(oxalato) borate (LiBOB).

12. The electrolyte as claimed in claim 1, wherein a concentration of the lithium salt is in a range of about 0.1 M to about 2.0 M.

13. A cyclic carbonate-based compound represented by Chemical Formula 1 or Chemical Formula 2: 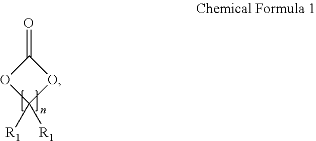
in Chemical Formula 1,
n is an integer of 2 to 5,
R₁(s) are each independently hydrogen, a substituted or unsubstituted C1 to C10 alkyl group, a substituted or unsubstituted C2 to C10 alkenyl group, a substituted or unsubstituted C2 to C10 alkynyl group, or an azide-containing group,
R₁(s) are each independently identical to or different from each other, and
at least one of R₁(s) is the azide-containing group, 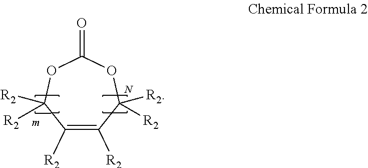
in Chemical Formula 2,
m is an integer of 0 to 3,
z is an integer of 0 to 3,
a sum of m and z is an integer of equal to or less than 3,
R₂(s) are each independently hydrogen, a substituted or unsubstituted C1 to C10 alkyl group, a substituted or unsubstituted C2 to C10 alkenyl group, a substituted or unsubstituted C2 to C10 alkynyl group, or the azide-containing group,
R₂(s) are each independently identical to or different from each other, and
at least one of R₂(s) is the azide-containing group.

14. The cyclic carbonate-based compound as claimed in claim 13, wherein the azide-containing group is an azide group or a substituted or unsubstituted C1 to C4 alkyl azide group.

15. The cyclic carbonate-based compound as claimed in claim 13, wherein the cyclic carbonate-based compound is represented by Chemical Formula 1-1 or Chemical Formula 2-1,

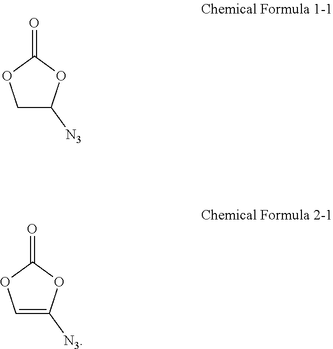 [SMILES: [N-]=[N+]=NC1COC(=O)O1 ; [N-]=[N+]=Nc1coc(=O)o1]

16. A rechargeable lithium battery, comprising:
a positive electrode comprising a positive electrode active material;
a negative electrode comprising a negative electrode active material; and
the electrolyte for the rechargeable lithium battery as claimed in claim 1.

17. The rechargeable lithium battery as claimed in claim 16, wherein the positive electrode active material comprises lithium composite oxide represented by Chemical Formula 3: 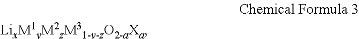
in Chemical Formula 3, 0.5≤x≤1.8, 0≤a≤0.05, 0<y≤1, 0≤z≤1, and 0≤y+z≤1,
M¹, M², and M³ each independently comprise at least one selected from among Ni, Co, Mn, Al, B, Ba, Ca, Ce, Cr, Fe, Mo, Nb, Si, Sr, Mg, Ti, V, W, Zr, La, and a combination thereof, and
X comprises at least one element selected from among F, S, P, and Cl.

18. The rechargeable lithium battery as claimed in claim 17, wherein, in Chemical Formula 3, M¹ is Ni.

19. The rechargeable lithium battery as claimed in claim 16, wherein the negative electrode active material comprises a carbon-based negative electrode active material, a Si-based negative electrode active material, a Sn-based negative electrode active material, or a combination thereof.

20. The rechargeable lithium battery as claimed in claim 19, wherein the Si-based negative electrode active material is a silicon-carbon composite.
